(19) United States
(12) Patent Application Publication
(10) Pub. No.: US 2011/0085351 A1
(43) Pub. Date: Apr. 14, 2011

(54) ILLUMINATION SYSTEM, BACKLIGHTING SYSTEM AND DISPLAY DEVICE

(75) Inventors: Fetze Pijlman, Eindhoven (NL); Michel C.J.M. Vissenberg, Eindhoven (NL); Marcellinus P.C.M. Krijn, Eindhoven (NL); Lars C. Casper, Eindhoven (NL)

(73) Assignee: KONINKLIJKE PHILIPS ELECTRONICS N.V., EINDHOVEN (NL)

(21) Appl. No.: 12/935,942

(22) PCT Filed: Apr. 1, 2009
(86) PCT No.: PCT/IB09/51363

§ 371 Date: Dec. 20, 2010

(30) Foreign Application Priority Data
Apr. 8, 2008 (EP) 08154187.2

(51) Int. Cl. F21V 7/22

(52) U.S. Cl. 362/607; 362/611; 362/606; 362/612; 362/613

(57) ABSTRACT

The invention relates to an illumination system (10), a backlighting system and a display device. The illumination system comprises a light source (20) configured to emit light via a light guide (30) to a light exit window (40) of the illumination system. The light guide has a front wall (32) arranged opposite a rear wall (34) so as to guide light in a direction substantially parallel to the front wall. A distance (D) between the light guide (30) and the light exit window (40) reduces towards an edge (42) of the light exit window (40). The light guide (30) further comprises a light entrance window (36) for receiving the light from the light source which is arranged away from the edge of the light exit window. The illumination system according to the invention has, inter alia, the effect that its thickness may be reduced at the edge of the light exit window.

### FIELD OF THE INVENTION

The invention relates to an illumination system comprising a light source configured to emit light via a light guide to a light exit window of the illumination system.

The invention also relates to a backlighting system and a display device.

### BACKGROUND OF THE INVENTION

Illumination systems which comprise a light source and a light guide for illuminating a light exit window of the illumination system are known per se. They are used, inter alia, as light sources in general illumination and in backlighting systems for (picture) display devices, for example, for TV sets and monitors. Such illumination systems are particularly suitable for use as backlighting systems for non-emissive display devices such as liquid crystal display devices, also denoted LCD panels, which are used in, for example, (portable) computers or, for example, (portable) telephones.

Said non-emissive display devices usually comprise a substrate provided with a regular pattern of pixels, each of which is controlled by at least one electrode. The display device utilizes a control circuit for achieving a picture or a data-graphical display in a relevant field of a (picture) screen of the (picture) display device. The light originating from the illumination system in an LCD device is modulated by means of a switch or modulator in which, for example, various types of liquid crystal effects may be used. In addition, the display may be based on electrophoretic or electromechanical effects.

Currently, there are two commonly used configurations of illumination systems for non-emissive display devices, viz. the direct-lit configuration and the edge-lit configuration. In the direct-lit configuration, the light sources are arranged in an array substantially parallel to the light exit window of the illumination system so as to substantially directly illuminate its entire exit window. The light sources may be, for example, an array of elongated low-pressure discharge lamps, or, for example, a two-dimensional array of light-emitting diodes. An example of such a direct-lit configuration can be seen in U.S. Pat. No. 7,052,152 showing a backlight in which a two-dimensional array of light-emitting diodes is used for illuminating a display. This direct-lit configuration has the drawback that the illumination system is relatively thick to allow the light to mix sufficiently uniformly before being emitted by the light exit window of the illumination system. In the edge-lit configuration, the illumination system generally comprises a light guide arranged parallel to the light exit window and having an edge wall through which (an array of) light sources emit(s) light into the light guide. The light is guided substantially parallel to the light exit window and is distributed throughout the light guide. The light is emitted through the light exit window by redirecting the guided light. Particularly for relatively large display devices, this edge-lit configuration has the drawback that the light guide has a considerable weight and that it is relatively difficult to generate a satisfactory uniformity particularly at an edge of the large light exit window where the light is coupled into the light guide. To improve this uniformity, wedge-shaped light guides as described in US 2007/0086184 are used. However, these wedge-shaped light guides further increase the weight and are also relatively difficult to manufacture for large light exit windows, and are thus expensive. Furthermore, the arrangement of the light sources at the edge wall of the light guide generally generates a relatively broad and thick rim around the display device, which does not only give it a less aesthetic appearance but also requires additional space when the display device is to be integrated in a further application or housing.

These known illumination systems thus have the drawback that they are relatively thick, particularly at their edge region.

### SUMMARY OF THE INVENTION

It is an object of the invention to provide an illumination system having a reduced thickness at its edge region.

In accordance with a first aspect of the invention, this object is achieved with an illumination system comprising a light source configured to emit light via a light guide to a light exit window of the illumination system, the light guide having a front wall arranged opposite a rear wall and being adapted to guide light in a direction substantially parallel to the front wall, the light guide comprising light-outcoupling structures for redirecting at least part of the guided light towards the light exit window via the front wall, a distance between the light guide and the light exit window reducing towards an edge of the light exit window, the light guide further comprising a light entrance window for receiving the light from the light source, the light entrance window being arranged away from the edge of the light exit window.

The distance between the light guide and the light exit window is measured along a normal axis with respect to the light exit window.

The illumination system according to the invention has, inter alia, the effect that it allows reduction of its thickness at the edge of its light exit window. The light guide in the illumination system according to the invention is typically arranged in such a way that a thickness of the illumination system reduces towards the edge of the light exit window. As such, the light guide may even contact the light exit window at the edge, generating a substantially minimum thickness of the illumination system at the edge of the light exit window. The light entrance window is arranged away from the edge and may be located, for example, at a normal axis with respect to the light exit window. In such an arrangement, the light entrance window of the light guide is arranged behind the light exit window of the illumination system, thus generating an illumination system which requires substantially no rim for housing the light sources and in which the edges of the illumination system may be extremely small and thus provide the preferred aesthetic appearance.

The arrangement according to the invention has the further advantage that the light entrance window is arranged away from the edge of the light exit window. Generally, the light-outcoupling structures have a relatively low density near the light source, which density increases when the distance to the light source increases. The reason for this gradient in the light-outcoupling structures is that the overall intensity of the light which is emitted from the light guide is preferably substantially constant across the front wall. Since the light near the light source has a higher intensity than that further away from the light source, only a few light-outcoupling structures are required near the light entrance window of the light guide. However, to maintain a relatively high uniformity across the light exit window of the illumination system, the areas of the light guide having relatively few outcoupling structures are preferably located further away from the light exit window, as otherwise the few outcoupling structures may be individually visible at the light exit window, even when a diffuser would be arranged at the light exit window. This would generate a relatively poor uniformity. In the arrangement according to the invention, the light entrance window of the light guide is arranged away from the edge of the light exit window of the illumination system. As such, the distance between the light entrance window of the light guide and the light exit window of the illumination system is relatively large, allowing the scattered light from the few outcoupling structures to mix before impinging on the light exit window. Further away from the light entrance window of the light guide, for example, near the edge of the light exit window of the illumination system, the density of the light-outcoupling structures is increased, causing the redirected light to be more uniform. A reduction of the distance between the light guide and the light exit window near the edge where the light-outcoupling structures have a relatively high density would thus not reduce the uniformity. As such, the illumination system according to the invention has a relatively good uniformity across the light exit window.

The known illumination systems are relatively thick at the edge of the light exit window due to the required mixing of the light emitted directly to the light exit window by the light sources (in a direct-lit configuration) or due to the incoupling and collimating optics required to couple the light of the light sources into the light guide (in an edge-lit configuration). At best, any of these known illumination systems may only be relatively thin at a single edge. In the illumination system according to the invention, the light entrance window of the light guide is arranged behind the light exit window of the illumination system, which allows an extremely thin edge of the illumination system and may be applied at all of its edges.

In an embodiment of the illumination system, the light guide comprises an edge wall arranged between the front wall and the rear wall, the edge wall being arranged at a maximum distance between the front wall and the light exit window and comprising the light entrance window for receiving the light from the light source. As such, the maximum distance between the light exit window and the light guide determines a maximum thickness of the illumination system. The required thickness is, for example, dependent on the density of the light-outcoupling structures near the light entrance window of the light guide. In such an embodiment, the light entrance window of the light guide is arranged substantially at a normal axis situated substantially at the center of the light exit window. As from this light entrance window, the light guide is shaped, for example, in such a way that the distance between the light guide and the light exit window reduces towards the edge of the light exit window of the illumination system. The edge wall may be identical to the light entrance window of the light guide. Alternatively, the light entrance window may be a part of the edge wall.

In an embodiment of the illumination system, the light guide has a substantially constant thickness which is a minimum dimension between the front wall and the rear wall. This embodiment has the advantage that the illumination system according to the invention has a relatively small weight. Although the illumination system according to the invention comprises a light guide, the light guide substantially has a constant thickness and further comprises light-outcoupling structures for redirecting the guided light towards the light exit window. As such, the light guide may be relatively thin, which limits its weight in comparison with a wedge-shaped light guide in the known illumination systems. The space between the light guide and the light exit window may be filled with a fluid, for example, air. The fluid between the light guide and the light exit window preferably allows the light guided in the light guide to propagate via total internal reflection through the light guide, as this allows a substantially lossless guiding of the light. Using air between the light guide and the light exit window further reduces the weight of the illumination system according to the invention.

In an embodiment of the illumination system, the light source is arranged at or arranged parallel to a normal axis with respect to the light exit window. The light source is thus arranged behind the light exit window of the illumination system, preferably at the maximum distance away from the light exit window. The normal axis does not need to be a symmetry axis of the illumination system. In an embodiment, in which the light source is a side-emitting light-emitting diode, the light source is preferably located at the normal axis which coincides with the symmetry axis. However, when the light source is constituted by a plurality of light emitters, each light emitter is preferably symmetrically located on either side of the symmetry axis, each on a different normal axis with respect to the light exit window of the illumination system. This embodiment has the advantage that it generates a relatively compact illumination system. This compact illumination system is especially enabled due to the availability of relatively small high-power light-emitting diodes which may be located at the light entrance window of the light guide, behind the light exit window.

In an embodiment of the illumination system, a shielding mirror is arranged between the light source and the light exit window for at least partially preventing direct illumination of the light exit window by the light source. Light emitted by the light source and directly impinging on the light exit window may reduce the uniformity across the light exit window. However, when the light source is positioned at a normal with the light exit window and the shielding mirror fully blocks all light which is emitted directly towards the light exit window, a relatively dark area near the light source on the light exit window may occur. As such, it may be advantageous to use a semitransparent shielding mirror which reduces the intensity of the light emitted by the light source directly towards the light exit window so that the light distribution across the light exit window is substantially uniform. This embodiment may have the further advantage that the light source is arranged at the light entrance window of the light guide which is preferably located at the maximum distance away from the light exit window. This relatively large distance may contribute to mixing light from the light guide with light directly emitted by the light source towards the light exit window so as to obtain a substantially uniform light distribution across the light exit window.

In an embodiment of the illumination system, a height between the shielding mirror and the light exit window is equal to or larger than half a width of the shielding mirror. The light guide may be, for example, a flat plate in which the front wall and the rear wall are substantially parallel surfaces. This flat plate may be arranged at the predefined angle with respect to the light exit window, in which the angle is defined by the dimensions of the shielding mirror. Generally, the distance between the shielding mirror and the light exit window of the illumination system should be substantially equal to (or larger than) half the width of the shielding mirror. In such an arrangement, the distance between the shielding mirror and the light exit window is used to mix the light emitted by the light guide with leakage, if any, through the shielding mirror, such that a relatively good uniformity is obtained across the light exit window. The dimensions of the shielding mirror may thus determine, for example, a minimum angle between the light guide and the light exit window.

In an embodiment of the illumination system, the light-outcoupling structures are arranged to generate a substantially uniform light distribution across the light exit window. As indicated hereinbefore, the light-outcoupling structures are generally distributed across the light guide in such a way that they have a relatively low density near the light source and that this density increases as the distance from the light source increases. The distribution of the light-outcoupling structures may change gradually or stepwise. Alternatively, the light-outcoupling structures may be distributed in such a way that they generate a predetermined light distribution, which, for example, may not be uniform across the light exit window. The light-outcoupling structures may be, for example, symmetrical grooves, asymmetrical grooves, pyramidal indentations, ridges, microdots, slanted slits, merlon structures, and conical indentations arranged, for example, either at the front wall or at the rear wall. Alternatively, the light-outcoupling structures may be scattering material distributed in the light guide. For example, when the light guide is constituted by polymethyl metacrylate (hereinafter also referred to as PMMA), the scattering material may be mixed with the PMMA before the PMMA is solidified.

In an embodiment of the illumination system, the light source is a side-emitting light-emitting diode emitting light substantially parallel to the light exit window. This embodiment has the advantage that the use of side-emitting light-emitting diodes generates an illumination system whose height as a whole is as small as possible while even further reducing its height towards the edge of the light exit window.

In an embodiment of the illumination system, a further part of the light guide comprising the light entrance window is curved so as to configure the light entrance window to be substantially parallel to the light exit window. In such an arrangement, the dimensions of the shielding mirror may be reduced substantially.

In an embodiment of the illumination system, the light source emits substantially white light, and/or the light source comprises a plurality of light emitters emitting light of a plurality of predefined colors.

In this context, light of a predefined color typically comprises light having a predefined spectrum. The predefined spectrum may comprise, for example, a primary color having a specific bandwidth around a predefined wavelength, or, for example, a plurality of primary colors. The predefined wavelength is a mean wavelength of a radiant power spectral distribution. In this context, light of a predefined color also includes non-visible light, such as ultraviolet light. When ultraviolet light is emitted by the light source, typically a light conversion medium is used, such as a luminescent material. The luminescent material, for example, converts the ultraviolet light into visible light. The conversion medium may be applied directly on or remote from the light source. The light of a primary color, for example, includes Red, Green, Blue, Yellow, Amber, and Magenta light. Light of the predefined color may also comprise mixtures of primary colors, such as Blue and Amber, or Blue, Yellow and Red. By choosing, for example, a specific combination of the Red, Green and Blue light, substantially every color can be generated by the illumination system, including white. Also other combinations of primary colors may be used in the light projection system, which allows the generation of substantially every color, for example, Red, Green, Blue, Cyan and Yellow. The number of primary colors used in the color-tunable illumination system may vary.

An embodiment of the illumination system further comprises a diffuser and/or a brightness enhancement foil and/or a redirection foil. The brightness enhancement foil may be, for example, a film commercially known as a dual brightness enhancement film (DBEF) comprising a reflective polarizer, such as the brightness enhancement film produced by the company 3M. The reflective polarizer transmits light having one direction of polarization and reflects light having the other direction of polarization back into the illumination system. In this way, light that would normally be emitted by the illumination system and absorbed by the first polarizing layer of the liquid crystal panel is recycled so as to increase the overall efficiency. The illumination system may also comprise the redirection foil, such as the foil described in WO 2004/079418. This foil has one surface comprising a transmissive prismatic structure for modifying the angular distribution of the light transmitted through the redirection foil.

Another embodiment of the illumination system further comprises a luminescent material or a mixture of luminescent materials for converting at least part of the light emitted by the light source into light having a longer wavelength. The luminescent material may be arranged, for example, on the front wall and/or on the rear wall of the light guide, or on a separate substrate arranged between the light source and the light exit window. Alternatively, the luminescent material may be arranged on the light exit window. Such an arrangement of the luminescent material is also known as a remote phosphor arrangement. Having the luminescent material remote from the light source provides the advantage that the efficiency of the luminescent material as well as the range of luminescent materials to choose from is improved due to the less stringent temperature requirements of the luminescent material in the remote phosphor arrangement, and the remote luminescent material also acts as a diffuser layer which diffuses the light emitted by the light source, thus avoiding the use of a separate diffuser.

The invention also relates to a backlighting system as defined in claim 13 and to a display device as defined in claim 14.

### BRIEF DESCRIPTION OF THE DRAWINGS

These and other aspects of the invention are apparent from and will be elucidated with reference to the embodiments described hereinafter.

In the drawings:

FIG. 1A is a simplified cross-sectional view of a first embodiment of the illumination system according to the invention,

FIGS. 1B, 1C and 1D are schematic three-dimensional views of the illumination system according to the invention,

FIG. 2 is a simplified cross-sectional view of a second embodiment of the illumination system according to the invention,

FIG. 3 is a simplified cross-sectional view of a third embodiment of the illumination system according to the invention, and

FIG. 4 is a simplified cross-sectional view of the display device according to the invention, comprising the backlighting system according to the invention.

The Figures are purely diagrammatic and not drawn to scale. Particularly for clarity, some dimensions are exaggerated strongly. Similar components in the Figures are denoted by the same reference numerals as much as possible.

### DESCRIPTION OF EMBODIMENTS

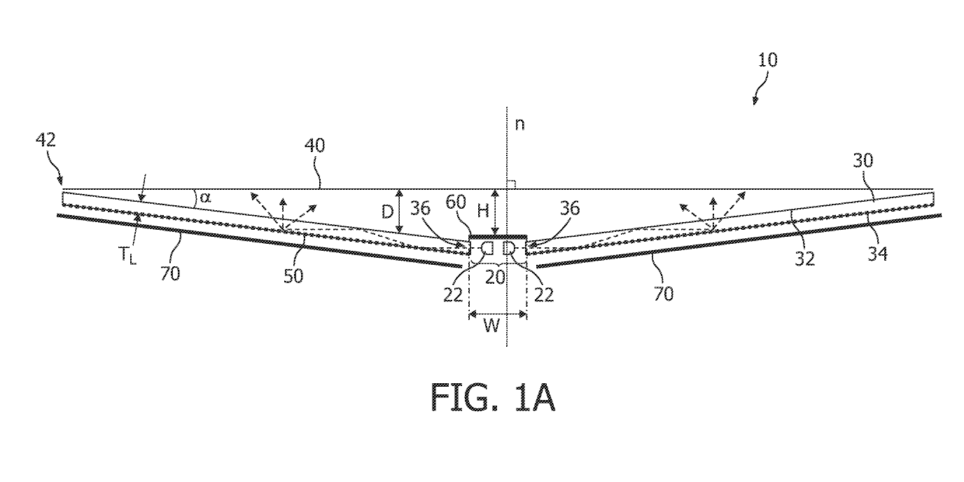

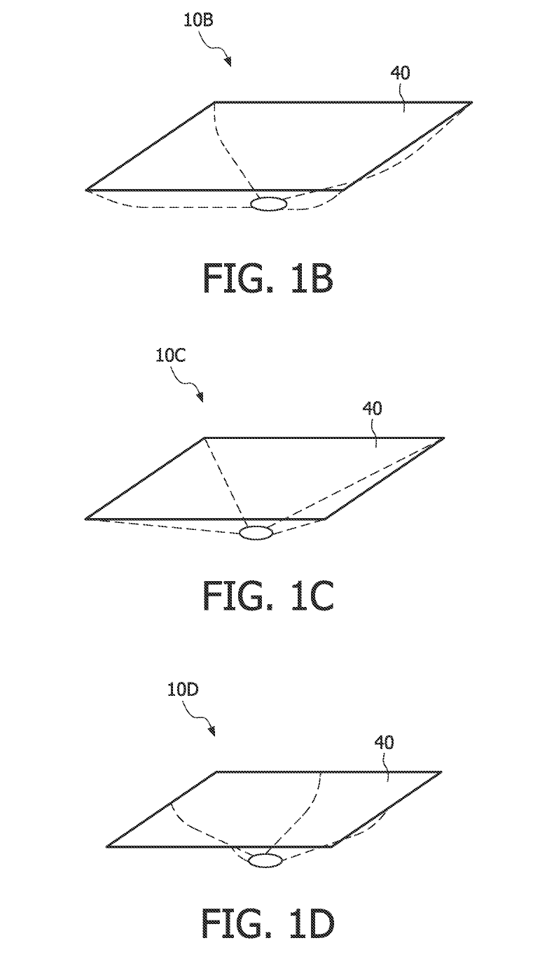

FIG. 1A is a simplified cross-sectional view of a first embodiment of the illumination system 10 according to the invention. The illumination system 10 as shown in FIG. 1A comprises a light source 20 which emits light via a light guide 30 towards a light exit window 40 of the illumination system 10. The light guide 30 comprises a front wall 32 located opposite a rear wall 34 and light-outcoupling structures 50 for redirecting at least part of the light guided by the light guide towards the light exit window 40 of the illumination system 10. In the embodiment shown in FIG. 1A, the light guide 30 has a substantially constant thickness T_{L} across the light guide. The light guide 30 further comprises a light entrance window 36 through which the light from the light source 20 enters the light guide 30 and is distributed through the light guide. The light guide 30 is arranged with respect to the light exit window 40 of the illumination system 10 in such a way that the distance between the light guide 30 and the light exit window 40 reduces towards an edge 42 of the light exit window 40. The light entrance window 36 is arranged away from the edge 42 of the light exit window 40 and is preferably arranged at or arranged parallel to a normal axis n of the light exit window 40. In such an arrangement, the light entrance window 36 is arranged behind the light exit window 40, which allows the light guide 30 to be very proximate to the light exit window 40 at the edge 42 of the light exit window 40 so that the illumination system 10 has a very narrow thickness at the edge 42 of the illumination system 10.

The configuration of the illumination system 10 as shown in FIG. 1A shows that the distance between the light source 20 and the light exit window 40 is relatively large. This is particularly advantageous when a shielding mirror 60 is used to shield or reduce an intensity of the light emitted by the light source 20 in a direction of the light exit window 40 and thus reduces or prevents light emitted by the light source 20 from directly illuminating the light exit window 40. Such a direct illumination of the light exit window 40 by the light source 20 would generate a relatively high intensity at the center of the light exit window 40 of the illumination system 10, thus reducing the uniformity across the light exit window 40. However, when the shielding mirror 60 is arranged too close to the light exit window 40, a relatively dark spot near the shielding mirror 60 may be observed at the light exit window 40. By having a relatively large distance between the shielding mirror 60 and the light exit window 40, the light emitted by the light guide 30 (and possibly some leakage of light emitted by the shielding mirror 60) may thus mix before impinging on the light exit window 40 and generate a substantially uniform distribution across the light exit window 40. The distance H between the shielding mirror 60 and the light exit window 40 should preferably be equal to or larger than half a width W of the shielding mirror 60. In such an arrangement, sufficient room for the mixing light is available to generate a substantially uniform distribution of the light. This difference between the shielding mirror 60 and the light exit window 40 may also define the predefined angle α between the light guide 30 and the light exit window 40.

Furthermore, the arrangement of the light source 20 at a relative distance from the light exit window 40 has the further advantage that the individual outcoupling structures 50 near the light source 20 may not be visible at the light exit window 40 and may thus not disturb the uniformity across the light exit window 40. In light guides 30 having light-outcoupling structures 50, these outcoupling structures 50 near the light source 20 generally have a relatively low density, while the density of the outcoupling structures 50 increases when the distance to the light source 20 increases. Such a distribution of the light-outcoupling structures 50 may be used to generate a substantially uniform distribution of the light across the light exit window 40. However, in a region in which the outcoupling structures 50 have a relatively low density, individual outcoupling structures 50 may be visible at the light exit window 40. This may be prevented by increasing the distance between the region in which the outcoupling structures 50 have a relatively low density and the light exit window 40. In the arrangement of the illumination system 10 as shown in FIG. 1A, this is solved because the distance between the light guide 30 decreases towards the edge 42 of the light exit window 40, while the light entrance window 36 of the light guide 30 is arranged away from the edge 42. In such an arrangement, the distance D between the light entrance window 36 and the light exit window 40 is relatively large. As the region in which the outcoupling structures have a relatively low density is arranged near or at the light entrance window 36, the relatively large distance D between the light entrance window 36 of the light guide 30 and the light exit window 40 of the illumination system 10 causes the light from the individual light-outcoupling structures 50 to mix before impinging on the light exit window 40 so that the individual light-outcoupling structures 50 are not visible and thus generate a relatively uniform distribution of the light across the light exit window 40.

The light source 20 may be a single light-emitting diode 22 which, for example, emits substantially white light, and/or it may comprise a plurality of light emitters 22 emitting light of a plurality of predefined colors.

The light guide 30 is preferably arranged to guide the light via total internal reflection, thus causing substantially lossless guiding of the light through the light guide. The light-outcoupling structures 50 of the light guide 30 may be distributed in such a way that they have a relatively low density near the light source 20 and that this density increases as the distance from the light source 20 increases. The distribution of the light-outcoupling structures 50 may change gradually or stepwise. Alternatively, the light-outcoupling structures 50 may be distributed in such a way that they generate a predetermined light distribution across the light exit window 40 which, for example, may not be uniform across the light exit window 40. The light-outcoupling structures 50 may be, for example, symmetrical grooves, asymmetrical grooves, pyramidal indentations, ridges, microdots, slanted slits, merlon structures, and conical indentations arranged, for example, either at the front wall or at the rear wall. Alternatively, the light-outcoupling structures may be scattering material distributed in the light guide 30.

In the embodiment shown in FIG. 1A, a reflective surface 70 is arranged parallel to and opposite from the rear wall 34 of the light guide 30. This reflective surface 70 redirects light progressing away from the light exit window 40 and back to the light exit window 40 so as to increase the efficiency of the illumination system 10. For example, light which is redirected by the outcoupling structures 50 towards the light exit window 40 but is reflected from the front wall 32 may progress away from the light exit window 40 and may be redirected by the reflective surface 70.

FIGS. 1B, 1C and 1D are schematic three-dimensional views of the illumination system 10 according to the invention. The broken lines indicate the shape of the front wall 32 of the light guide 30. As can be seen from FIGS. 1B, 1C and 1D, the light guide 30 may have diverse shapes. Each of these shapes may have a different distribution of light-outcoupling structures 50 so as to generate a substantially uniform distribution of the light across the light exit window 40.

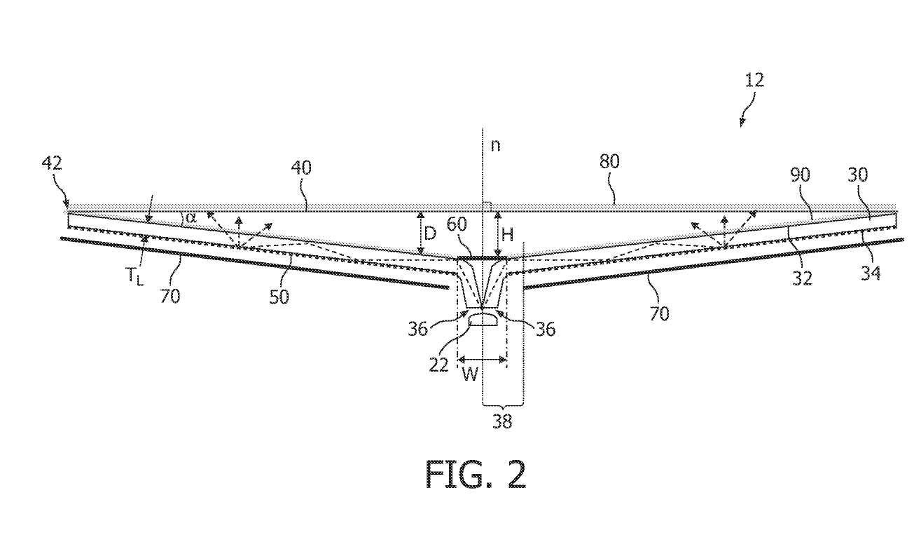

FIG. 2 is a simplified cross-sectional view of a second embodiment of the illumination system 12 according to the invention. In the embodiment shown in FIG. 2, a further part 38 of the light guide 30 which comprises the light entrance window 36 is curved away from the light exit window 40. This curved part 38 causes the light entrance window 36 to be arranged substantially parallel to the light exit window 40. In the embodiment shown, a single light emitter 22 may be sufficient to provide the light to the light guide 30. This arrangement has the advantage that the shielding mirror 60 may be relatively small (a relatively small width W) or may even be omitted completely. In the schematic cross-sectional view shown in FIG. 2, the further part 38 of the light guide 30 has a relatively sharp curvature. This curvature may be preferably chosen to be such that still most of the light is guided by the light guide 30 via total internal reflection. In the embodiment in which no shielding mirror is required, the distance H between the light exit window 40 and the light source 22 may be reduced.

The illumination system 12 as shown in FIG. 2 further comprises an additional layer 80 on the light exit window 40. This additional layer 80 may be a diffuser and/or a brightness enhancement foil and/or a redirection foil. The illumination system 12 may also comprise a luminescent material 90 or a mixture of luminescent materials 90 for converting at least part of the light emitted by the light source 22 into light having a longer wavelength. In the embodiment shown in FIG. 2, the luminescent material 90 is arranged on the front wall 32 of the light guide 30. Alternatively, the luminescent material 90 may be arranged on the rear wall 34, or mixed inside the light guide or arranged on the light exit window 40 of the illumination system 12.

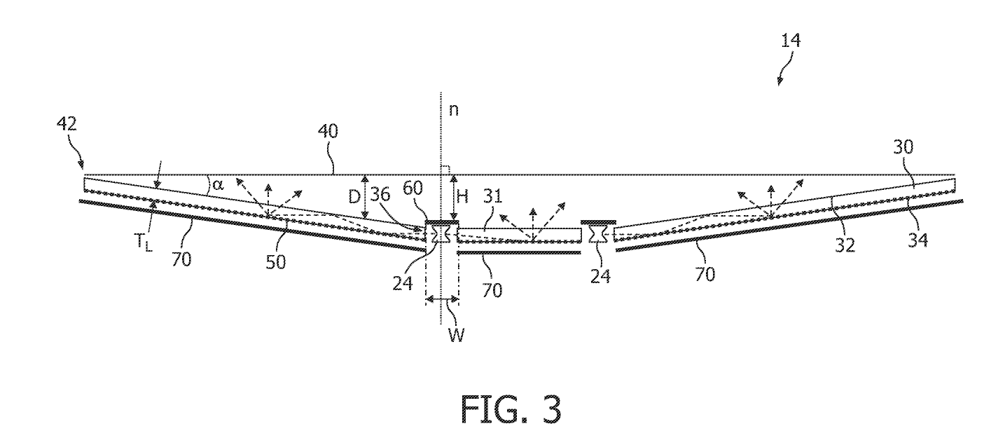

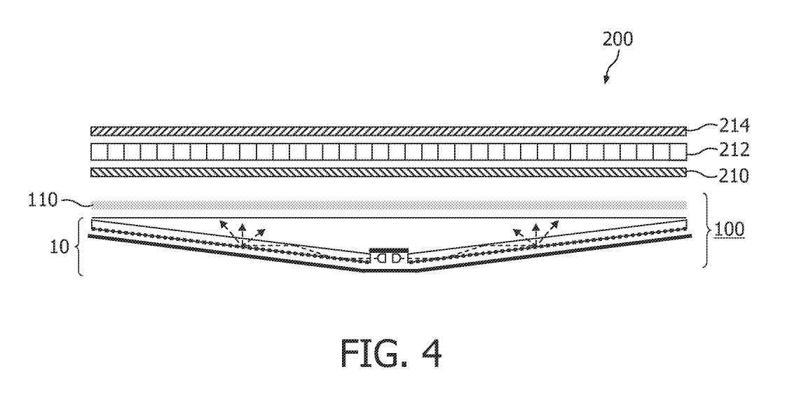

FIG. 3 is a simplified cross-sectional view of a third embodiment of the illumination system 14 according to the invention. In this third embodiment, the light guide 30 comprises an additional center part 31 for guiding the light emitted by the light source 24. This center part 31 may be arranged, for example, substantially parallel to the light exit window 40. This embodiment has the advantage that it allows the number of light sources 24 arranged in the illumination system 14 to be increased while still having a relatively thin illumination system 14 at the edge 42 of the light exit window 40. An increased number of light sources 24 increases the light which may be coupled out by the illumination system 14 via the light exit window 40, for example, in a direction of a display device (see FIG. 4). In the embodiment shown in FIG. 3, the light source 24 is a side-emitting light-emitting diode. The side-emitting light-emitting diodes 24 shown in FIG. 3 emit the light in a general direction substantially parallel to the light exit window 40. The emitted light is coupled both into the light guide 30 and into the center part 31 of the light guide 30. Again, the light source 24 is arranged at a normal axis n with respect to the light exit window 40, and is thus again arranged behind the light exit window 40. The distance D between the light guide 30 and the light exit window 40 decreases towards the edge 42 of the light exit window 40, thus still allowing a relatively narrow edge of the illumination system 14. In the arrangement shown in FIG. 3, the center part 31 is relatively small as compared to the light guide 30. However, as the center part 31 receives light from both side-emitting light-emitting diodes 24, it may have larger dimensions than those of the light guide 30, thus providing an illumination system in which the light exit window 40, which may be extremely large, may be illuminated substantially uniformly, while the thickness of the illumination system 14 decreases towards the edge 42 of the light exit window 40.

FIG. 4 is a simplified cross-sectional view of a display device 200 according to the invention, comprising a backlighting system 100 according to the invention. The display device 200 may be, for example, a liquid crystal display device which comprises a layer of electrically connected (not shown) liquid crystal cells 212, a polarizing layer 210, and an analyzing layer 214. Alternatively, the display device 200 may be any other non-emissive display device. The display device 200 comprises a backlighting system 100 comprising the illumination system 10 as shown in FIG. 1A. The backlighting system 100 may further comprise a diffuser layer 110. The diffuser layer 110 may constitute the light exit window 40 of the illumination system 10.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. An illumination system comprising a light source configured to emit light via a light guide to a light exit window of the illumination system, the light guide having a front wall arranged opposite a rear wall and being adapted to guide light in a direction substantially parallel to the front wall, the light guide comprising light-outcoupling structures for redirecting at least part of the guided light towards the light exit window via the front wall for generating a predetermined light distribution across the light exit window, the light guide further comprising a light entrance window for receiving the light from the light source, the light entrance window being arranged away from an edge of the light exit window and being arranged at a normal axis (n) of the light exit window, a distance (D) between the front wall of the light guide and the light exit window reducing towards two opposite edges of the light exit window.

2. An illumination system as claimed in claim 1, wherein the light guide comprises an edge wall arranged between the front wall and the rear wall, the edge wall being arranged at a maximum distance (D) between the front wall and the light exit window and comprising the light entrance window for receiving the light from the light source.

3. An illumination system as claimed in claim 1, wherein the light guide has a substantially constant thickness (T_{L}) which is a minimum dimension between the front wall and the rear wall.

4. An illumination system as claimed in claim 1, wherein the light source is arranged at or arranged parallel to a normal axis (n) with respect to the light exit window.

5. An illumination system as claimed in claim 4, wherein a shielding mirror is arranged between the light source and the light exit window for at least partially preventing direct illumination of the light exit window by the light source.

6. An illumination system as claimed in claim 5, wherein a height (H) between the shielding mirror and the light exit window is equal to or larger than half a width (W) of the shielding mirror.

7. An illumination system as claimed in claim 1, wherein the light-outcoupling structures are arranged to generate a substantially uniform light distribution cross the light exit window.

8. An illumination system as claimed in claim 1, wherein the light source is a side-emitting light-emitting diode emitting light substantially parallel to the light exit window.

9. An illumination system as claimed in claim 1, wherein a further part (38) of the light guide comprising the light entrance window is curved so as to configure the light entrance window to be substantially parallel to the light exit window.

10. An illumination system as claimed in claim 1, wherein the light source emits substantially white light, and/or wherein the light source comprises a plurality of light emitters emitting light of a plurality of predefined colors.

11. An illumination system as claimed in claim 1, further comprising a diffuser and/or a brightness enhancement foil and/or a redirection foil.

12. An illumination system as claimed in claim 1, further comprising a luminescent material or a mixture of luminescent materials for converting at least part of the light emitted by the light source into light having a longer wavelength.

13. A backlighting system (100) comprising the illumination system as claimed in claim 1.

14. A display device (200) comprising the illumination system as claimed in claim 1.

15. An illumination system as claimed in claim 1, wherein the light source is configured for illuminating the light exit window substantially only via the light guide.
